(19) United States
(12) Patent Application Publication
(10) Pub. No.: US 2002/0017816 A1
(43) Pub. Date: Feb. 14, 2002

(54) Device for supporting a tipping hopper of a tipper vehicle

(76) Inventor: Kurt Theopold, Lemgo (DE)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/815,578

(22) Filed: Mar. 23, 2001

(30) Foreign Application Priority Data
Mar. 24, 2000 (DE) 100 14 860.3

(51) Int. Cl. B60P 1/04

(52) U.S. Cl. 298/17 T

(57) ABSTRACT

The device has a frame element of light construction which carries an abutment plate. The latter comprises frictional material and affords an abutment surface whose coefficient of friction is set at 1.15. If torsional distortion of the frame element should occur during operation, the abutment plate permits sliding movement of the abutment surface on an opposing surface on the tipping hopper. The abutment plate is thus kept free of transverse stresses and is thereby protected from premature destruction. However, it can damp rotary movements of the tipping hopper to a satisfactory extent and reliably guide them.

### FIELD OF THE INVENTION

The invention relates to a device for supporting a tipping hopper on at least one frame element of a tipper vehicle including an abutment plate, which is rigidly connected to one of the components comprising the frame element and the tipping hopper, and an abutment surface for bearing against an opposing surface on the other of the two components.

### DESCRIPTION OF THE PRIOR ART

It is known in practice to manufacture the abutment plate from elastic material, particularly material similar to rubber. It has transpired that such abutment plates are subject to comparatively rapid wear. It is necessary to replace the abutment plates correspondingly frequently. The expense caused thereby is in no way negligible, not only as a result of the material and work which are necessary but also, above all, as a result of the inevitable stoppage times of the tipper vehicle.

It is thus the object of the invention to reduce the maintenance expense of the device referred to above.

### SUMMARY OF THE INVENTION

In order to solve this object, the device referred to above is characterised in accordance with the invention in that the abutment surface of the abutment plate is constituted by a frictional material and that the coefficient of friction of the abutment surface is in the range of 0.1 to 0.2.

The invention is based on the recognition that the high cost of maintenance of the elastic abutment plates is due to the light construction being widely adopted in vehicle assembly, that is to say also in the assembly of utility vehicles and, above all, in the assembly of special vehicles. The entire chassis of modern tipper vehicles is of light construction including the auxiliary frame on which the tipping hopper is supported. As a result of the light construction, torsional stresses of the frame elements inevitably occur, in operation. These frame elements torsionally distort so that the known abutment plates are subject to transverse stresses which they are unable to cope with. The rubber-like material fatigues and is destroyed.

The frictional material used in accordance with the invention, on the other hand, imparts to the abutment surface of the abutment plate a relatively low coefficient of friction which is in the lower range of solid body friction. If torsion of the Same element occurs, the abutment surface slides over the opposing surface. Transverse stresses of the abutment plate are thus minimised. Favourable conditions thus prevail in the abutment plate in accordance with the invention for this reason. An additional factor is that the frictional material has a rigid consistency and thus has a high mechanical load bearing ability. Overall, the surface life of the abutment plates used in accordance with the invention is well above that of the known abutment plates of rubber-like material.

It has transpired surprisingly that the consistency of the frictional material is able to damp the impact of the tipping hopper and that despite the low coefficient of friction of the frictional material there is very good damping of the transverse movements of the hopper. The abutment plates used in accordance with the invention thus ensure very good and reliable guiding of the tipping hopper during tipping and driving operation.

The high wear resistance of the frictional material should finally also be mentioned in association with practically complete temperature independence of the characteristics which are crucial in the present case (in the temperature range of −50° C. to +300° C.) and a high resistance to operationally caused contamination, for instance by oils and greases.

The abutment plate can readily comprise composite material and, for instance, have a base body of rigid or elastic material, which carries a layer of greater or lesser thickness of the frictional material constituting the abutment surface. An elastic base body can improve the damping characteristics and is protected from harmful transverse loads thanks to the frictional material. However, it is frequently advantageous for manufacturing reasons to manufacture the abutment plate in its entirety from the frictional material, particularly if it is able to satisfy the crucial demands on it, when used alone.

There is of course the possibility of arranging the abutment plate on the tipping hopper but it can be more advantageous for maintenance reasons to secure the abutment plate to the frame element, whereby it preferably engages around the latter and is connected to it by moulding onto or around it.

The number of the abutment plates is matched to the prevailing requirements. It is frequently advantageous to work with a single abutment plate per frame element.

In an important embodiment of the invention it is proposed that the frictional material is moulded from a moulding composition which contains

30-45% bonding agent,

35-44% textile, mineral or glass fibres or chips or mixtures thereof,

5-14% processing adjuvants and

0-8% friction modifying means.

A moulding composition has proved to be particularly satisfactory which contains

30-45% bonding agent,

5-10% setting agent,

30-40% textile chips,

5-15% textile threads,

0-8% friction modifying means and

1-4% black pigments.

It is advantageous if the bonding agent comprises phenol novolak and the setting agent comprises hexamethylene tetramine. In further embodiment of the invention it is proposed as an alternative that the frictional material contains

15-30% bonding agent,

10-30% fibres,

10-25% fillers and

20-60% friction modifying means.

In every case, it is advantageous if the friction modifying means comprises PTFE.

Finally, a preferred embodiment is characterised in that a sintered material, comprising iron and/or non-ferrous metals and/or carbon and/or phosphorous and/or sulphur and/or alloys thereof and/or compounds thereof is used as the frictional material in an amount of at least 50 vol. % and one or more lubricants/ sliding agents.

The invention will be described in more detail below by way of a preferred exemplary embodiment in conjunction with the attached drawings.

### BRIEF DESCRIPTION OF THE DRAWINGS

FIG. 1 is a schematic side view of a device in accordance with the invention;

FIG. 2 is a schematic plan view of the device shown in FIG. 1.

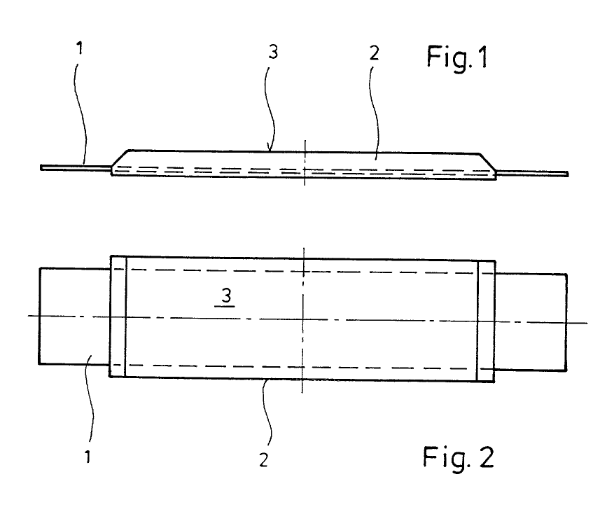

### DESCRIPTION OF THE PREFERRED EMBODIMENTS

The illustrated device is a frame element 1 of light construction, which carries an abutment plate 2. The abutment plate 2 comprises frictional material and engages around the frame element 1.

The abutment plate 2 defines an abutment surface 3, the coefficient of friction of which is set at 0.15.

The device serves to support a tipping hopper of a tipper vehicle, the abutment surface 3 of the abutment plate 2 coming into engagement with an opposing surface on the tipping hopper. When torsional distortion of the frame element 1 occurs, relative movement of the abutment plate 2 and the tipping hopper is permitted.

The frictional material of the abutment plate 2 contains

35% phenol novolak as a bonding agent,

8% hexamethylene tetramine as a setting agent,

35% textile chips,

10% textile threads,

4% PTFE as a friction modifying agent and

2% black pigments.

These components of the frictional material are mixed to form a moulding composition. The latter is injected around the frame element 1 and then subjected to a pressure and temperature treatment under appropriate time control. A surface treatment of the abutment surface completes the manufacturing process.

A highly wear-resistant frictional material is produced, as can be used, for instance, also for brake and clutch linings.

Modifications are of course possible within the scope of the invention. Thus the abutment plate can be constructed in the form of a laminated body, so long as its abutment surface is constituted by frictional material. There is also the possibility of prefabricating the abutment plate and positioning it on one side of the frame element. Furthermore, each frame element can carry a plurality of abutment plates. Finally, the Fame element can define an opposing surface, whereby the abutment plate is disposed on the tipping hopper.

1. A device for supporting a first component of a tipper vehicle on at least one second component of the tipper vehicle, the first component being a tipping hopper and the second component being a frame element, including at least one abutment plate, which is rigidly connected to one of the components and has an abutment surface for bearing against an opposing surface on the other component, the abutment surface of the abutment plate being constituted by a frictional material and the abutment surface having a coefficient of friction in the range of about 0.1-0.2.

2. The device as claimed in claim 1, wherein the abutment plate engages around the frame element.

3. The device as claimed in claim 1, wherein the abutment plate consists of the frictional material.

4. The device as claimed in claim 3, wherein the frictional material is injection moulded onto the frame element.

5. The device as claimed in claim 1, wherein the frictional material is moulded from a moulding composition which contains
30-45% bonding agent,
35-55% of at least one component from a group of components which comprises textile, mineral and glass fibres, textile, mineral and glass chips and mixtures of these components,
5-14% processing adjuvants and
0-8% friction modifying agent.

6. The device as claimed in claim 5, wherein the moulding composition contains
30-45% bonding agent,
5-10% setting agent,
30-40% textile chips,
5-15% textile threads,
0-8% friction modifying agent and
1-4% black pigments.

7. The device as claimed in claim 6, wherein the bonding agent comprises phenol novolak and the setting agent comprises hexamethylene tetramine.

8. The device as claimed in claim 5, wherein the friction modifying agent comprises PTFE.

9. The device as claimed in claim 1, wherein the frictional material contains
15-30% bonding agent,
10-30% fibres,
10-25% filters and
20-60% friction modifying means.

10. The device as claimed in claim 9, wherein the friction modifying agent comprises PTFE.

11. The device as claimed in claim 1, wherein a sintered material, which comprises at least one material from a group of materials which comprises iron, non-ferrous metals, carbon, phosphorous, sulphur, alloys thereof and compounds thereof; is used as the frictional material in an amount of at least 50 vol. % and further contains at least one lubricant.
